(19) United States
(12) Patent Application Publication
(10) Pub. No.: US 2014/0052853 A1
(43) Pub. Date: Feb. 20, 2014

(54) Unmoderated Remote User Testing and Card Sorting

(71) Applicants: Xavier Mestres, Barcelona (ES); Albert Recolons, Calella (ES); Francesc del Castillo, Mataro (ES)

(72) Inventors: Xavier Mestres, Barcelona (ES); Albert Recolons, Calella (ES); Francesc del Castillo, Mataro (ES)

(21) Appl. No.: 14/060,914

(22) Filed: Oct. 23, 2013

Related U.S. Application Data
(63) Continuation-in-part of application No. 13/112,792, filed on May 20, 2011.
(60) Provisional application No. 61/348,431, filed on May 26, 2010.

(51) Int. Cl. H04L 12/26

(52) U.S. Cl. CPC H04L 43/0876
USPC 709/224

(57) ABSTRACT

A computer-implemented method for performing unmoderated remote usability testing of an executable software module. The method includes identifying a multitude of participants, each of the multitude of participants being equipped with a data processing unit adapted to receive a multitude of responses from the multitude of participants. Each of the multitude of responses may be associated with using the executable software module. The method further includes connecting the multitude of participants with a server, automatically presenting at least one of a multitude of tasks associated with at least one usability metric of the executable software module to at least one of the multitude of participants, and gathering the at least one of the multitude of responses related to the at least one of the multitude of tasks.

### CROSS-REFERENCES TO RELATED APPLICATIONS

The present application is a continuation-in-part of commonly assigned U.S. Non-Provisional application Ser. No. 13/112,792 titled “System and Method For Unmoderated Remote User Testing And Card Sorting” filed May 20, 2011, which claims priority to commonly assigned U.S. Provisional Application No. 61/348,431 titled “System and Method for Unmoderated Remote User Testing and Card Sorting” filed May 26, 2010, the contents of all of which are incorporated herein by reference in their entirety.

### BACKGROUND

The present invention relates to computer systems and more particularly to gathering usability data for a web site.

The Internet provides new opportunities for business entities to reach customers via web sites that promote and describe their products or services. Often, the appeal of a web site and its ease of use may affect a potential buyer's decision to purchase the product/service.

Assessing the appeal, user friendliness, and effectiveness of a web site is of substantial value to marketing managers, web site designers and user experience specialists but is unfortunately difficult to obtain. Focus groups are sometimes used to achieve this goal but the process is long, expensive and not reliable, in part, due to the size and demographics of the focus group that may not be representative of the target customer base.

Therefore, there is a need to provide a low cost, quick and reliable way of gathering usability data using the Internet.

### BRIEF SUMMARY

In an embodiment of the present invention, a method of performing usability testing of a target web site includes identifying a group of participants, each participant is equipped with a data processing unit having a display screen and running a web browsing software program. The method further includes inserting a proprietary program code to each of the group of participants' web browsing software program for tracking their interaction with the website or mockup. In addition, the method includes automatically presenting questions and/or tasks to the group of participants; and gathering responses or reactions from each participant using a computer system. Furthermore, the method includes sending the participant's responses to a data collecting server comprising a validation module configured to validate the gathered responses and a binning module configured to store the validated responses into multiple categories.

In another embodiment, the displayed web site is not the original target web site but a modified one. In an embodiment, a tracking code is added to a web page that is being downloaded by a participant. The tracking code may be a JavaScript code executed by the data processing unit. In yet another embodiment, not the answers of the entire group of participants will be analyzed. Certain participants will be eliminated based on a predefined list of qualification rules. For example, participants can be selected based on their gender, age, education, income, personal interests, and the like.

In an embodiment of the present invention, a computer-aided method of performing usability testing of a target web site includes modifying a current software of the target web site by adding a proprietary program code to it and selecting a group of participants based on a list of predefined selection criteria. Further, the method includes automatically presenting questions from a predefined list of questions to the selected participants and gathering answers of the selected participants related to the questions from the predefined list of questions, wherein the predefined list of questions is related to a usability metric of the target web site.

In an embodiment of the present invention, a system for performing remote usability testing of a software application includes a module for generating and storing particular tasks and a module for moderating a session (or a moderating session module) with a number of remote participants. The system further includes a module for receiving usability data. Additionally, the system includes a module for analyzing the received usability data. In an embodiment, the module for generating and storing the particular tasks includes a research server configured to interface with user experience researchers who may create multiple testing modules for selecting qualified participants from the number of participants and for generating the particular tasks having research metrics associated with a target web site. In an embodiment, the selection of qualified participants can be performed by profiling the number of participants. In another embodiment, the research server may randomly assign one of the multiple testing modules to one or more of the number of participants. In yet another embodiment, the multiple testing modules may include card sorting studies for optimizing a web site's architecture or layout.

In an embodiment, the moderating session module interacts with the remote participants via a browser, which may be configured to transmit a plurality of browser events generated by the number of participants. The moderating session module may be embedded in a moderator server that may be linked to a study content database and/or a behavioral database. In an embodiment, the browser may include a proprietary software program code. In an embodiment, the downloaded target web site is being modified in real-time with a proprietary tracking code, and the browsing events such as clicks, scrolls, key strokes will be gathered during a period of time. In another embodiment, the browser is a standard browser such as Microsoft Internet Explorer™, Chrome™ or Firefox™, and the target web site contains a proprietary tracking code.

In another embodiment of the present invention, a device for gathering usability data includes a module adapted to present a list of predefined tasks to a participant. The module is further adapted to gather the participant's responses related to the list of predefined tasks and send the gathered responses to a data collection server. In an embodiment, the list of predefined tasks includes tasks of determining content and usability of a target web site, and the web site may be modified in real-time with a virtual tracking code while being downloaded to the participant. The virtual tracking code may be a proprietary Javascript code.

In yet another embodiment of the present invention, a program stored on a computer readable medium includes codes for presenting a list of predefined tasks to a participant, codes for gathering the participant's responses associated with the list of predefined tasks, and codes for analyzing participant's responses.

### BRIEF DESCRIPTION OF THE DRAWINGS

FIG. 1A is a simplified block diagram illustrating a first embodiment of the present invention.

FIG. 1B is a simplified block diagram illustrating a second embodiment of the present invention.

FIG. 1C is a simplified block diagram illustrating a third embodiment of the present invention.

FIG. 2 is a simplified block diagram illustrating an exemplary platform according to an embodiment of the present invention.

FIG. 3A is a flow diagram illustrating an exemplary process of interfacing with potential candidates and pre-screening participants for the usability testing according to an embodiment of the present invention.

FIG. 3B is a flow diagram of an exemplary process for collecting usability data of a target web site according to an embodiment of the present invention.

FIG. 3C is a flow diagram of an exemplary process for card sorting studies according to an embodiment of the present invention.

FIG. 4 is a simplified block diagram of a data processing unit configured to enable a participant to access a web site and track participant's interaction with the web site according to an embodiment of the present invention.

FIG. 5 is a simplified block diagram illustrating a fourth embodiment of the present invention.

FIG. 6A is a simplified block diagram illustrating a fifth embodiment of the present invention.

FIG. 6B is a simplified block diagram illustrating a sixth embodiment of the present invention.

FIG. 7A is a flow diagram of an exemplary process for gathering usability data for the embodiment depicted in FIG. 6A, according to an embodiment of the present invention.

FIG. 7B is a flow diagram of an exemplary process for gathering usability data for the embodiment depicted in FIG. 6B, according to an embodiment of the present invention.

FIG. 8 is a flow diagram of an exemplary process for presenting a task and recording a response for the embodiments depicted in FIGS. 7A-7B, according to an embodiment of the present invention.

### DETAILED DESCRIPTION

In the following it is understood that the term usability refers to a metric scoring value for judging the ease of use of a target web site. A client refers to a sponsor who initiates and/or finances the usability study. The client may be, for example, a marketing manager who seeks to test the usability of a commercial web site for marketing (selling or advertising) certain products or services. Participants may be a selected group of people who participate in the usability study and may be screened based on a predetermined set of questions. Remote usability testing or remote usability study refers to testing or study in accordance with which participants (referred to use their computers, mobile devices or otherwise) access a target web site in order to provide feedback about the web site's ease of use, connection speed, and the level of satisfaction the participant experiences in using the web site. Unmoderated usability testing refers to communication with test participants without a moderator, e.g., a software, hardware, or a combined software/hardware system can automatically gather the participants' feedback and records their responses. The system can test a target web site by asking participants to view the web site, perform test tasks, and answer questions associated with the tasks.

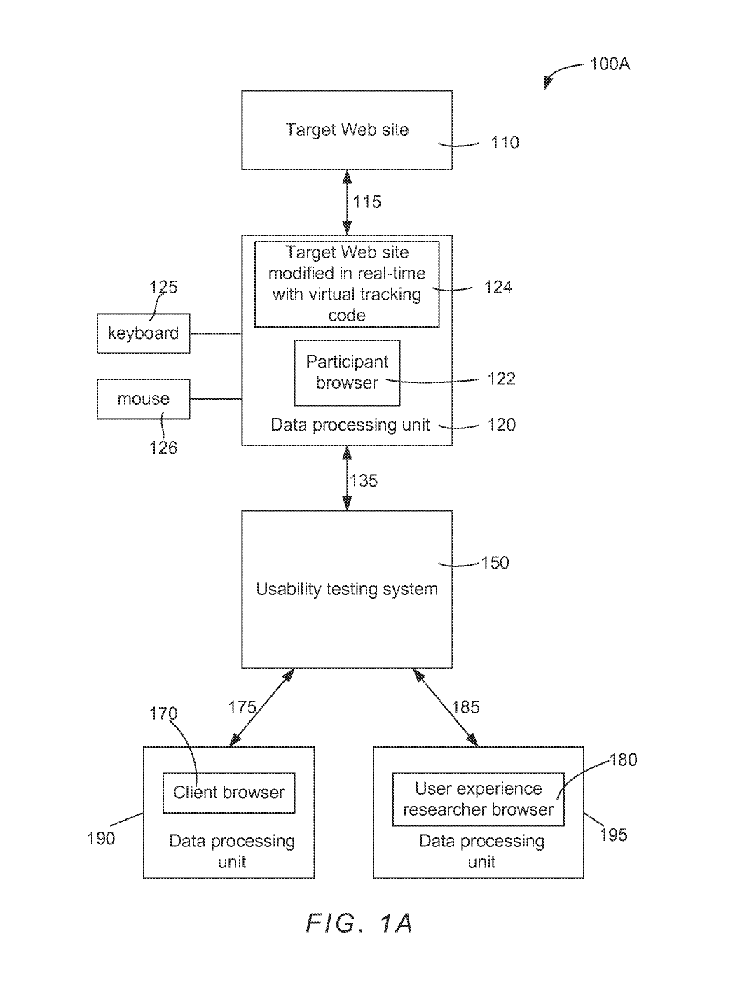

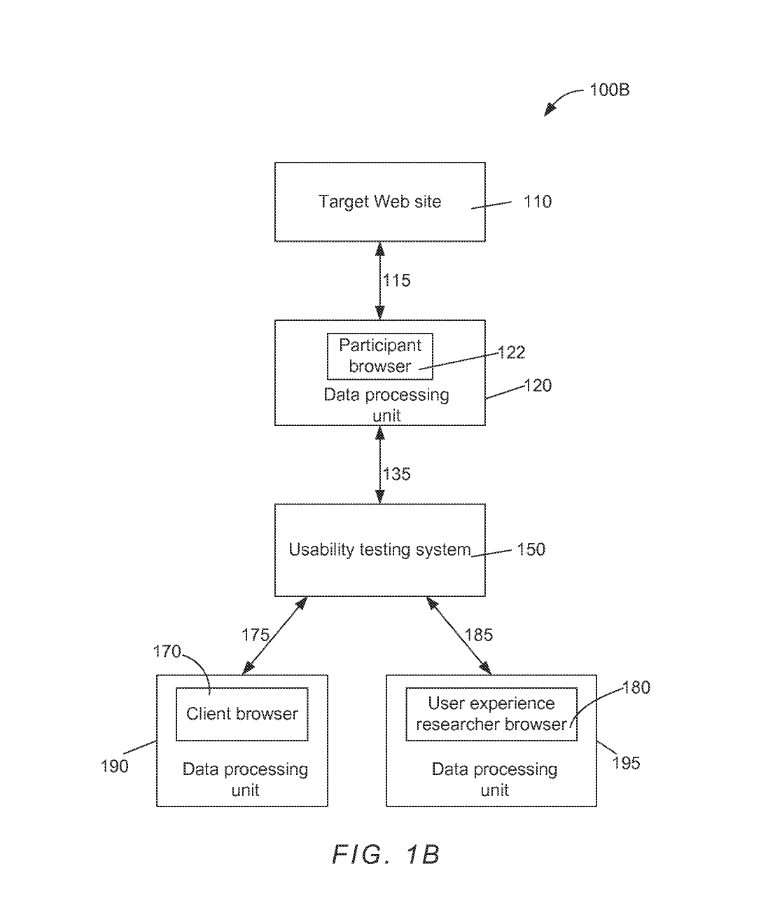

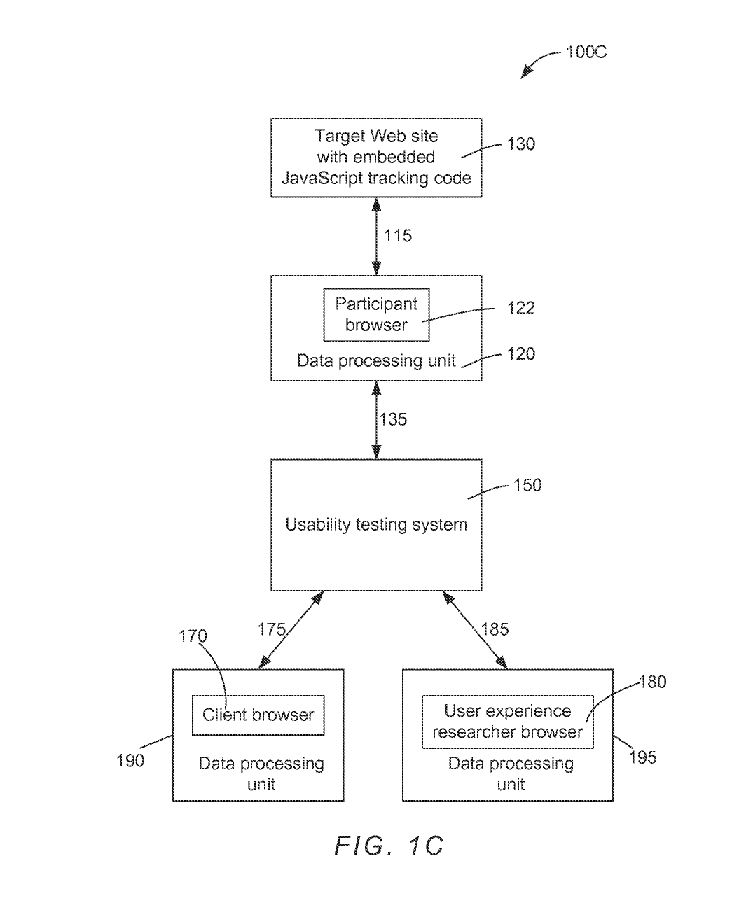

FIG. 1A is a simplified block diagram of a user testing platform 100A according to an embodiment of the present invention. Platform 100A is adapted to test a target web site 110. Platform 100A is shown as including a usability testing system 150 that is in communications with data processing units 120, 190 and 195. Data processing units 120, 190 and 195 may be a personal computer equipped with a monitor, a handheld device such as a tablet PC, an electronic notebook, a wearable device such as a cell phone, or a smart phone.

Data processing unit 120 includes a browser 122 that enables a user (e.g., usability test participant) using the data processing unit 120 to access target web site 110. Data processing unit 120 includes, in part, an input device such as a keyboard 125 or a mouse 126, and a participant browser 122. In one embodiment, data processing unit 120 may insert a virtual tracking code to target web site 110 in real-time while the target web site is being downloaded to the data processing unit 120. The virtual tracking code may be a proprietary JavaScript code, whereby the run-time data processing unit interprets the code for execution. The tracking code collects participants' activities on the downloaded web page such as the number of clicks, key strokes, keywords, scrolls, time on tasks, and the like over a period of time. Data processing unit 120 simulates the operations performed by the tracking code and is in communication with usability testing system 150 via a communication link 135. Communication link 135 may include a local area network, a metropolitan area network, a wide area network. Such a communication link may be established through a physical wire or wirelessly. For example, the communication link may be established using an Internet protocol such as the TCP/IP protocol. Activities of the participants associated with target web site 110 are collected and sent to usability testing system 150 via communication link 135. In one embodiment, data processing unit 120 may instruct a participant to perform predefined tasks on the downloaded web site during a usability test session, in which the participant evaluates the web site based on a series of usability tests. The virtual tracking code (i.e., a proprietary JavaScript) may record the participant's responses (such as the number of mouse clicks) and the time spent in performing the predefined tasks. The usability testing may also include gathering performance data of the target web site such as the ease of use, the connection speed, the satisfaction of the user experience. Because the web page is not modified on the original web site, but on the downloaded version in the participant data processing unit, the usability can be tested on any web sites including competitions' web sites.

All data collected by data processing unit 120 may be sent to the usability testing system 150 via communication link 135. In an embodiment, usability testing system 150 is further accessible by a client via a client browser 170 running on data processing unit 190. Usability testing system 150 is further accessible by user experience researcher browser 180 running on data processing unit 195. Client browser 170 is shown as being in communications with usability testing system 150 via communication link 175. User experience research browser 180 is shown as being in communications with usability testing system 150 via communications link 185. A client and/or user experience researcher may design one or more sets of questionnaires for screening participants and for testing the usability of a web site. Usability testing system 150 is described in detail below.

FIG. 1B is a simplified block diagram of a user testing platform 100B according to another embodiment of the present invention. Platform 100B is shown as including a target web site 110 being tested by one or more participants using a standard web browser 122 running on data processing unit 120 equipped with a display. Participants may communicate with a usability test system 150 via a communication link 135. Usability test system 150 may communicate with a client browser 170 running on a data processing unit 190. Likewise, usability test system 150 may communicate with user experience researcher browser running on data processing unit 195. Although a data processing unit is illustrated, one of skill in the art will appreciate that data processing unit 120 may include a configuration of multiple single-core or multi-core processors configured to process instructions, collect usability test data (e.g., number of clicks, mouse movements, time spent on each web page, connection speed, and the like), store and transmit the collected data to the usability testing system, and display graphical information to a participant via an input/output device (not shown).

FIG. 1C is a simplified block diagram of a user testing platform 100C according to yet another embodiment of the present invention. Platform 100C is shown as including a target web site 130 being tested by one or more participants using a standard web browser 122 running on data processing unit 120 having a display. The target web site 130 is shown as including a tracking program code configured to track actions and responses of participants and send the tracked actions/responses back to the participant's data processing unit 120 through a communication link 115. Communication link 115 may be computer network, a virtual private network, a local area network, a metropolitan area network, a wide area network, and the like. In one embodiment, the tracking program is a JavaScript configured to run tasks related to usability testing and sending the test/study results back to participant's data processing unit for display. such embodiments advantageously enable clients using client browser 170 as well as user experience researchers using user experience research browser 180 to design mockups or prototypes for usability testing of variety of web site layouts. Data processing unit 120 may collect data associated with the usability of the target web site and send the collected data to the usability testing system 150 via a communication link 135.

In one exemplary embodiment, the testing of the target web site (page) may provides data such as ease of access through the Internet, its attractiveness, ease of navigation, the speed with which it enables a user to complete a transaction, and the like. In another exemplary embodiment, the testing of the target web site provides data such as duration of usage, the number of keystrokes, the user's profile, and the like. It is understood that testing of a web site in accordance with embodiments of the present invention can provide other data and usability metrics.

Information collected by the participant's data processing unit is uploaded to usability testing system 150 via communication link 135 for storage and analysis.

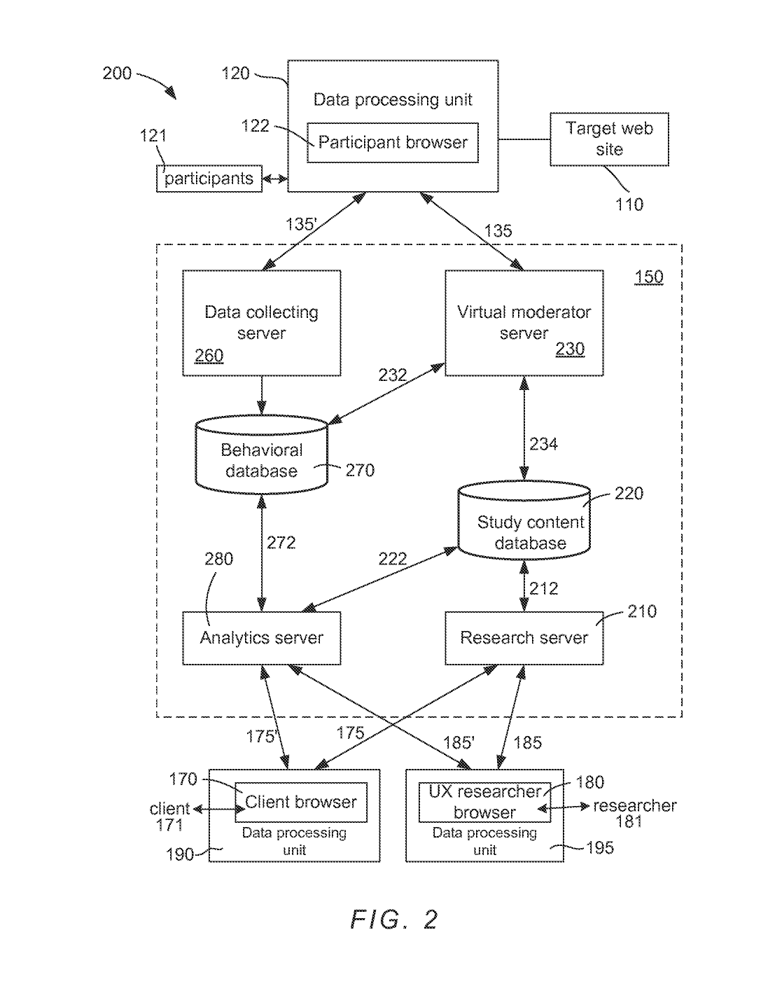

FIG. 2 is a simplified block diagram of an exemplary embodiment platform 200 according to one embodiment of the present invention. Platform 200 is shown as including, in part, a usability testing system 150 being in communications with a data processing unit 120 via communications links 135 and 135′. Data processing unit 120 includes, in part, a participant browser 122 that enables a participant to access a target web site 110. Data processing unit 120 may be a personal computer, a handheld device, such as a cell phone, a smart phone or a tablet PC, or an electronic notebook. Data processing unit 120 may receive instructions and program codes from usability testing system 150 and display predefined tasks to participants 121. The instructions and program codes may include a web-based application that instructs participant browser 122 to access the target web site 110. In one embodiment, a tracking code is inserted to the target web site 110 that is being downloaded to data processing unit 120. The tracking code may be a JavaScript code that collects participants' activities on the downloaded target web site such as the number of clicks, key strokes, movements of the mouse, keywords, scrolls, time on tasks and the like performed over a period of time.

Data processing unit 120 may send the collected data to usability testing system 150 via communication link 135′ which may be a local area network, a metropolitan area network, a wide area network, and the like and enable usability testing system 150 to establish communication with data processing unit 120 through a physical wire or wirelessly using a packet data protocol such as the TCP/IP protocol or a proprietary communication protocol.

Usability testing system 150 includes a virtual moderator software module running on a virtual moderator server 230 that conducts interactive usability testing with a usability test participant via data processing unit 120 and a research module running on a research server 210 that may be connected to a user research experience data processing unit 195. User experience researcher 181 may create tasks relevant to the usability study of a target web site and provide the created tasks to the research server 210 via a communication link 185. One of the tasks may be a set of questions designed to classify participants into different categories or to prescreen participants. Another task may be, for example, a set of questions to rate the usability of a target web site based on certain metrics such as ease of navigating the web site, connection speed, layout of the web page, ease of finding the products (e.g., the organization of product indexes). Yet another tasks may be a survey asking participants to press a “yes” or “no” button or write short comments about participants' experiences or familiarity with certain products and their satisfaction with the products. All these tasks can be stored in a study content database 220, which can be retrieved by the virtual moderator module running on virtual moderator server 230 to forward to participants 121. Research module running on research server 210 can also be accessed by a client (e.g., a sponsor of the usability test) 171 who, like user experience researchers 181, can design their own questionnaires since the client has a personal interest to the target web site under study. Client 171 can work together with user experience researchers 181 to create tasks for usability testing. In an embodiment, client 171 can modify tasks or lists of questions stored in the study content database 220. In another embodiment, client 171 can add or delete tasks or questionnaires in the study content database 220. In yet another embodiment, client 171 may be user experience researcher 181.

In one embodiment, one of the tasks may be open or closed card sorting studies for optimizing the architecture and layout of the target web site. Card sorting is a technique that shows how online users organize content in their own mind. In an open card sort, participants create their own names for the categories. In a closed card sort, participants are provided with a predetermined set of category names. Client 171 and/or user experience researcher 181 can create proprietary online card sorting tool that executes card sorting exercises over large groups of participants in a rapid and cost-effective manner. In an embodiment, the card sorting exercises may include up to 100 items to sort and up to 12 categories to group. One of the tasks may include categorization criteria such as asking participants questions “why do you group these items like this?.” Research module on research server 210 may combine card sorting exercises and online questionnaire tools for detailed taxonomy analysis. In an embodiment, the card sorting studies are compatible with SPSS applications.

In an embodiment, the card sorting studies can be assigned randomly to participant 121. User experience (UX) researcher 181 and/or client 171 may decide how many of those card sorting studies each participant is required to complete. For example, user experience researcher 181 may create a card sorting study within 12 tasks, group them in 4 groups of 3 tasks and manage that each participant just has to complete one task of each group.

After presenting the thus created tasks to participants 121 through virtual moderator module (running on virtual moderator serer 230) and communication link 135, the actions/responses of participants will be collected in a data collecting module running on a data collecting server 260 via a communication link 135′. In an embodiment, communication link 135′ may be a distributed computer network and share the same physical connection as communication link 135. This is, for example, the case where data collecting module 260 locates physically close to virtual moderator module 230, or if they share the usability testing system's processing hardware. In the following description, software modules running on associated hardware platforms will have the same reference numerals as their associated hardware platform. For example, virtual moderator module will be assigned the same reference numeral as the virtual moderator server 230, and likewise data collecting module will have the same reference numeral as the data collecting server 260.

Data collecting module 260 may include a sample quality control module that screens and validates the received responses, and eliminates participants who provide incorrect responses, or do not belong to a predetermined profile, or do not qualify for the study. Data collecting module 260 may include a “binning” module that is configured to classify the validated responses and stores them into corresponding categories in a behavioral database 270. Merely as an example, responses may include gathered web site interaction events such as clicks, keywords, URLs, scrolls, time on task, navigation to other web pages, and the like. In one embodiment, virtual moderator server 230 has access to behavioral database 270 and uses the content of the behavioral database to interactively interface with participants 121. Based on data stored in the behavioral database, virtual moderator server 230 may direct participants to other pages of the target web site and further collect their interaction inputs in order to improve the quantity and quality of the collected data and also encourage participants' engagement. In one embodiment, virtual moderator server may eliminate one or more participants based on data collected in the behavioral database. This is the case if the one or more participants provide inputs that fail to meet a predetermined profile.

Usability testing system 150 further includes an analytics module 280 that is configured to provide analytics and reporting to queries coming from client 171 or user experience (UX) researcher 181. In an embodiment, analytics module 280 is running on a dedicated analytics server that offloads data processing tasks from traditional servers. Analytics server 280 is purpose-built for analytics and reporting and can run queries from client 171 and/or user experience researcher 181 much faster (e.g., 100 times faster) than conventional server system, regardless of the number of clients making queries or the complexity of queries. The purpose-built analytics server 280 is designed for rapid query processing and ad hoc analytics and can deliver higher performance at lower cost, and, thus provides a competitive advantage in the field of usability testing and reporting and allows a company such as UserZoom (or Xperience Consulting, SL) to get a jump start on its competitors.

In an embodiment, research module 210, virtual moderator module 230, data collecting module 260, and analytics server 280 are operated in respective dedicated servers to provide higher performance. Client (sponsor) 171 and/or user experience research 181 may receive usability test reports by accessing analytics server 280 via respective links 175′ and/or 185′. Analytics server 280 may communicate with behavioral database via a two-way communication link 272.

In an embodiment, study content database 220 may include a hard disk storage or a disk array that is accessed via iSCSI or Fibre Channel over a storage area network. In an embodiment, the study content is provided to analytics server 280 via a link 222 so that analytics server 280 can retrieve the study content such as task descriptions, question texts, related answer texts, products by category, and the like, and generate together with the content of the behavioral database 270 comprehensive reports to client 171 and/or user experience researcher 181.

Shown in FIG. 2 is a connection 232 between virtual moderator server 230 and behavioral database 270. Behavioral database 270 can be a network attached storage server or a storage area network disk array that includes a two-way communication via link 232 with virtual moderator server 230. Behavioral database 270 is operative to support virtual moderator server 230 during the usability testing session. For example, some questions or tasks are interactively presented to the participants based on data collected. It would be advantageous to the user experience researcher to set up specific questions that enhance the usability testing if participants behave a certain way. If a participant decides to go to a certain web page during the study, the virtual moderator server 230 will pop up corresponding questions related to that page; and answers related to that page will be received and screened by data collecting server 260 and categorized in behavioral database server 270. In some embodiments, virtual moderator server 230 operates together with data stored in the behavioral database to proceed to the next steps. Virtual moderator server, for example, may need to know whether a participant has successfully completed a task, or based on the data gathered in behavioral database 270, present another tasks to the participant.

Referring still to FIG. 2, client 171 and user experience researcher 181 may provide one or more sets of questions associated with a target web site to research server 210 via respective communication link 175 and 185. Research server 210 stores the provided sets of questions in a study content database 220 that may include a mass storage device, a hard disk storage or a disk array being in communication with research server 210 through a two-way interconnection link 212. The study content database may interface with virtual moderator server 230 through a communication link 234 and provides one or more sets of questions to participants via virtual moderator server 230.

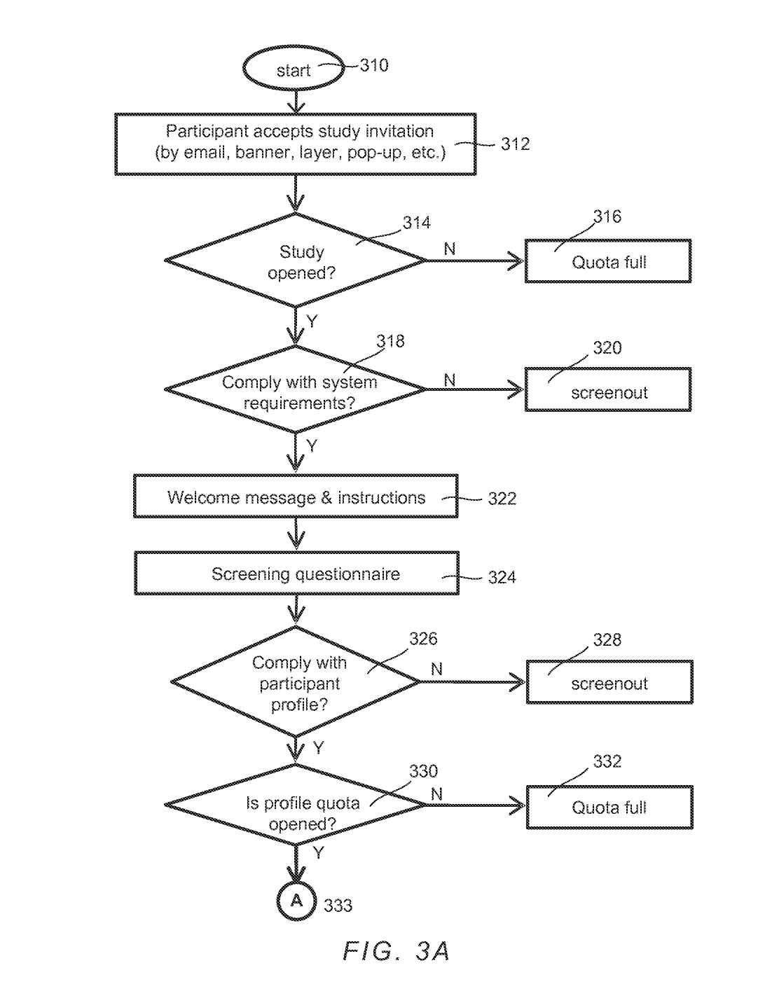

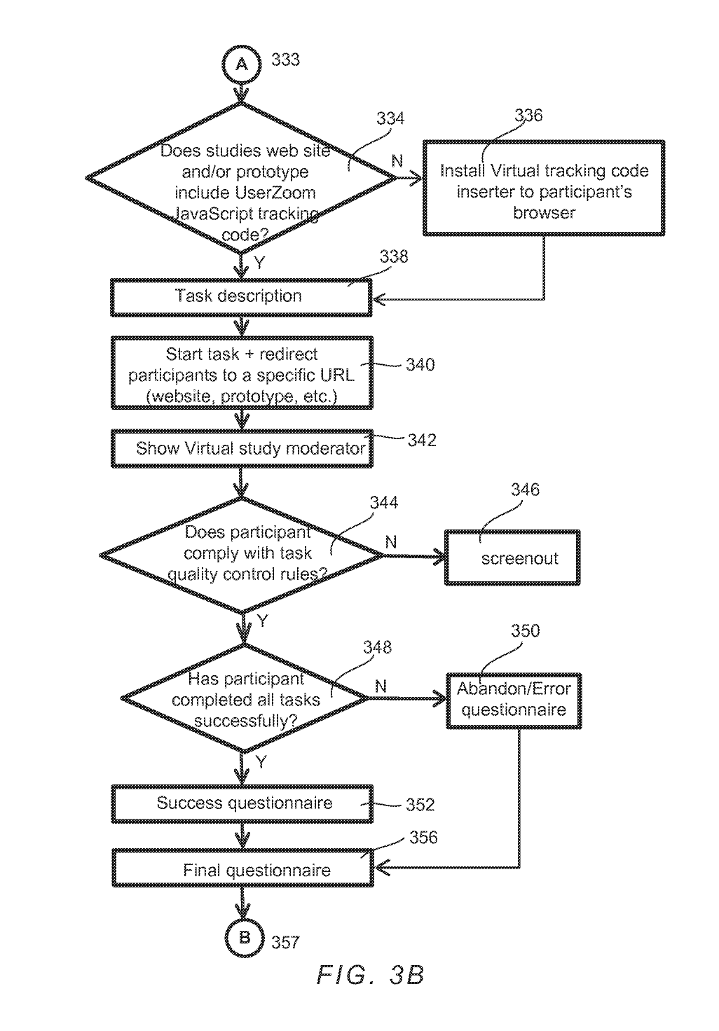

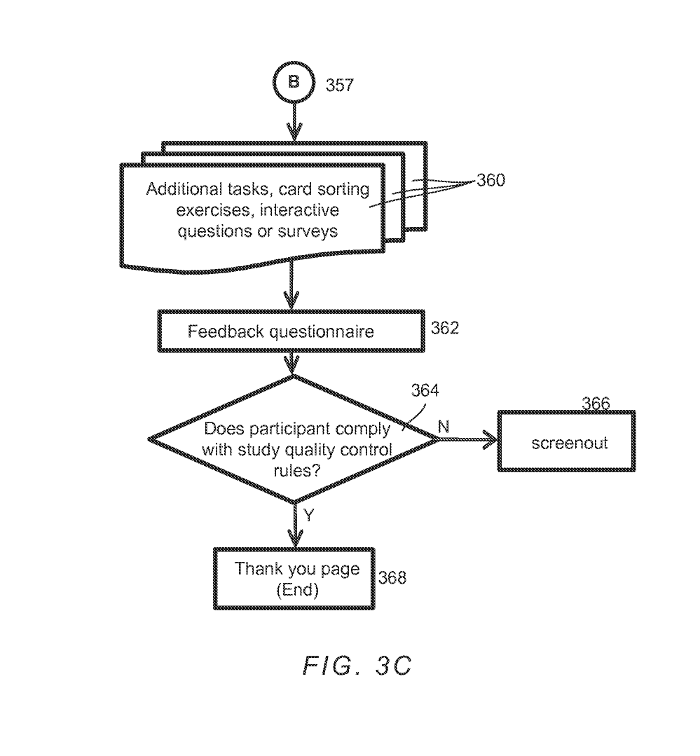

FIG. 3A is a flow diagram of an exemplary process of interfacing with potential candidates and prescreening participants for the usability testing according to one embodiment of the present invention. The process starts at step 310. Initially, potential candidates for the usability testing may be recruited by email, advertisement banners, pop-ups, text layers, overlays, and the like (step 312). The number of candidates who have accepted the invitation to the usability test will be determined at step 314. If the number of candidates reaches a predetermined target number, then other candidates who have signed up late may be prompted with a message thanking for their interest and that they may be considered for a future survey (shown as “quota full” in step 316). At step 318, the usability testing system further determines whether the participants' browser comply with a target web site browser. For example, user experience researchers or the client may want to study and measure a web site's usability with regard to a specific web browser (e.g., Microsoft Internet Explorer) and reject all other browsers. Or in other cases, only the usability data of a web site related to Opera or Chrome will be collected, and Microsoft IE or FireFox will be rejected at step 320. At step 322, participants will be prompted with a welcome message and instructions are presented to participants that, for example, explain how the usability testing will be performed, the rules to be followed, and the expected duration of the test, and the like. At step 324, one or more sets of screening questions may be presented to collect profile information of the participants. Questions may relate to participants' experience with certain products, their awareness with certain brand names, their gender, age, education level, income, online buying habits, and the like. At step 326, the system further eliminates participants based on the collected information data. For example, only participants who have used the products under study will be accepted or screened out (step 328). At step 330, a quota for participants having a target profile will be determined. For example, half of the participants must be female, and they must have online purchase experience or have purchased products online in recent years.

FIG. 3B is a flow diagram of an exemplary process for gathering usability data of a target web site according to an embodiment of the present invention. At step 334, the target web site under test will be verified whether it includes a proprietary tracking code. In an embodiment, the tracking code is a UserZoom JavaScript code that pop-ups a series of tasks to the pre-screened participants. If the web site under study includes a proprietary tracking code (this corresponds to the scenario shown in FIG. 1C), then the process proceeds to step 338. Otherwise, a virtual tracking code will be inserted to participants' browser at step 336. This corresponds to the scenario described above in FIG. 1A.

The following process flow is best understood together with FIG. 2. At step 338, a task is described to participants. The task can be, for example, to ask participants to locate a color printer below a given price. At step 340, the task may redirect participants to a specific web site such as eBay, HP, or Amazon.com. The progress of each participant in performing the task is monitored by a virtual study moderator at step 342. At step 344, responses associated with the task are collected and verified against the task quality control rules. The step 344 may be performed by the data collecting module 260 described above and shown in FIG. 2. Data collecting module 260 ensures the quality of the received responses before storing them in a behavioral database 270 (FIG. 2). Behavioral database 270 may include data that the client and/or user experience researcher want to determine such as how many web pages a participant viewed before selecting a product, how long it took the participant to select the product and complete the purchase, how many mouse clicks and text entries were required to complete the purchase and the like. A number of participants may be screened out (step 346) during step 344 for non complying with the task quality control rules and/or the number of participants may be required to go over a series of training provided by the virtual moderator module 230. At step 348, virtual moderator module 230 determines whether or not participants have completed all tasks successfully. If all tasks are completed successfully (e.g., participants were able to find a web page that contains the color printer under the given price), virtual moderator module 230 will prompt a success questionnaire to participants at step 352. If not, then virtual moderator module 230 will prompt an abandon or error questionnaire to participants who did not complete all tasks successfully to find out the causes that lead to the incompletion. Whether participants have completed all task successfully or not, they will be prompted a final questionnaire at step 356.

FIG. 3C is a flow diagram of an exemplary process for card sorting studies according to one embodiment of the present invention. At step 360, participants may be prompted with additional tasks such as card sorting exercises. Card sorting is a powerful technique for assessing how participants or visitors of a target web site group related concepts together based on the degree of similarity or a number of shared characteristics. Card sorting exercises may be time consuming. In an embodiment, participants will not be prompted all tasks but only a random number of tasks for the card sorting exercise. For example, a card sorting study is created within 12 tasks that is grouped in 6 groups of 2 tasks. Each participant just needs to complete one task of each group. It should be appreciated to one person of skill in the art that many variations, modifications, and alternatives are possible to randomize the card sorting exercise to save time and cost. Once the card sorting exercises are completed, participants are prompted with a questionnaire for feedback at step 362. The feedback questionnaire may include one or more survey questions such as a subjective rating of target web site attractiveness, how easy the product can be used, features that participants like or dislike, whether participants would recommend the products to others, and the like. At step 364, the results of the card sorting exercises will be analyzed against a set of quality control rules, and the qualified results will be stored in the behavioral database 270. In an embodiment, the analyze of the result of the card sorting exercise is performed by a dedicated analytics server 280 that provides much higher performance than general-purpose servers to provide higher satisfaction to clients. If participants complete all tasks successfully, then the process proceeds to step 368, where all participants will be thanked for their time and/or any reward may be paid out. Else, if participants do not comply or cannot complete the tasks successfully, the process proceeds to step 366 that eliminates the non-compliant participants.

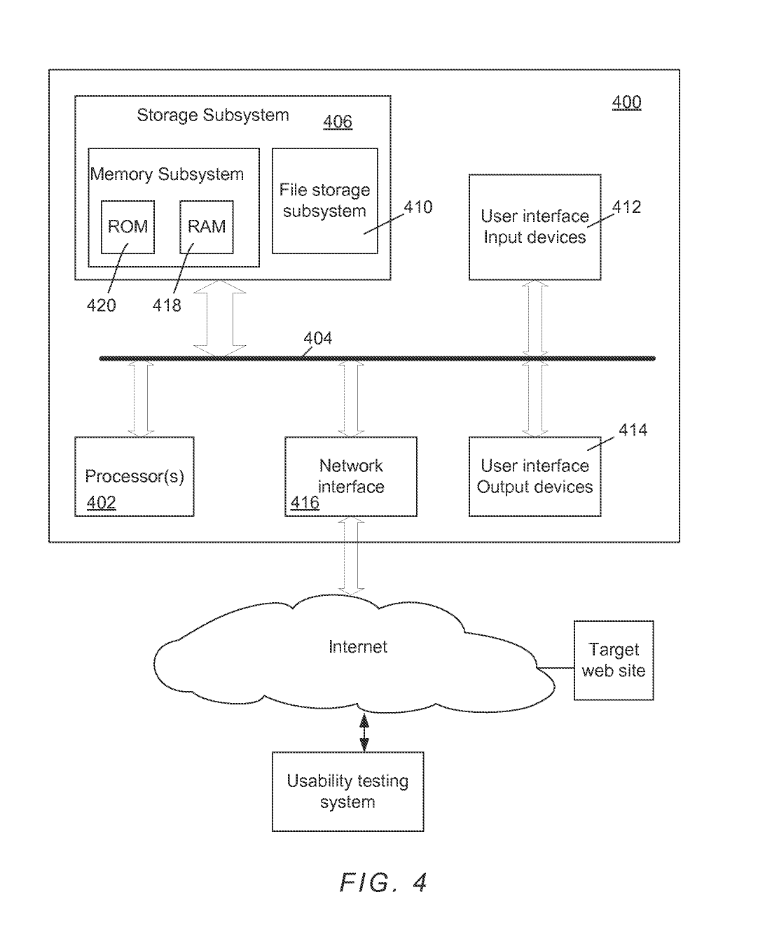

FIG. 4 illustrates an example of a suitable data processing unit 400 configured to connect to a target web site, display web pages, gather participant's responses related to the displayed web pages, interface with a usability testing system, and perform other tasks according to an embodiment of the present invention. System 400 is shown as including at least one processor 402, which communicates with a number of peripheral devices via a bus subsystem 404. These peripheral devices may include a storage subsystem 406, including, in part, a memory subsystem 408 and a file storage subsystem 410, user interface input devices 412, user interface output devices 414, and a network interface subsystem 416 that may include a wireless communication port. The input and output devices allow user interaction with data processing system 402. Bus system 404 may be any of a variety of bus architectures such as ISA bus, VESA bus, PCI bus and others. Bus subsystem 404 provides a mechanism for enabling the various components and subsystems of the processing device to communicate with each other. Although bus subsystem 404 is shown schematically as a single bus, alternative embodiments of the bus subsystem may utilize multiple busses.

User interface input devices 412 may include a keyboard, pointing devices such as a mouse, trackball, touchpad, or graphics tablet, a scanner, a barcode scanner, a touch screen incorporated into the display, audio input devices such as voice recognition systems, microphones, and other types of input devices. In general, use of the term input device is intended to include all possible types of devices and ways to input information to processing device. User interface output devices 414 may include a display subsystem, a printer, a fax machine, or non-visual displays such as audio output devices. The display subsystem may be a cathode ray tube (CRT), a flat-panel device such as a liquid crystal display (LCD), or a projection device. In general, use of the term output device is intended to include all possible types of devices and ways to output information from the processing device.

Storage subsystem 406 may be configured to store the basic programming and data constructs that provide the functionality in accordance with embodiments of the present invention. For example, according to one embodiment of the present invention, software modules implementing the functionality of the present invention may be stored in storage subsystem 406. These software modules may be executed by processor(s) 402. Such software modules can include codes configured to access a target web site, codes configured to modify a downloaded copy of the target web site by inserting a tracking code, codes configured to display a list of predefined tasks to a participant, codes configured to gather participant's responses, and codes configured to cause participant to participate in card sorting exercises. Storage subsystem 406 may also include codes configured to transmit participant's responses to a usability testing system.

Memory subsystem 408 may include a number of memories including a main random access memory (RAM) 418 for storage of instructions and data during program execution and a read only memory (ROM) 420 in which fixed instructions are stored. File storage subsystem 410 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

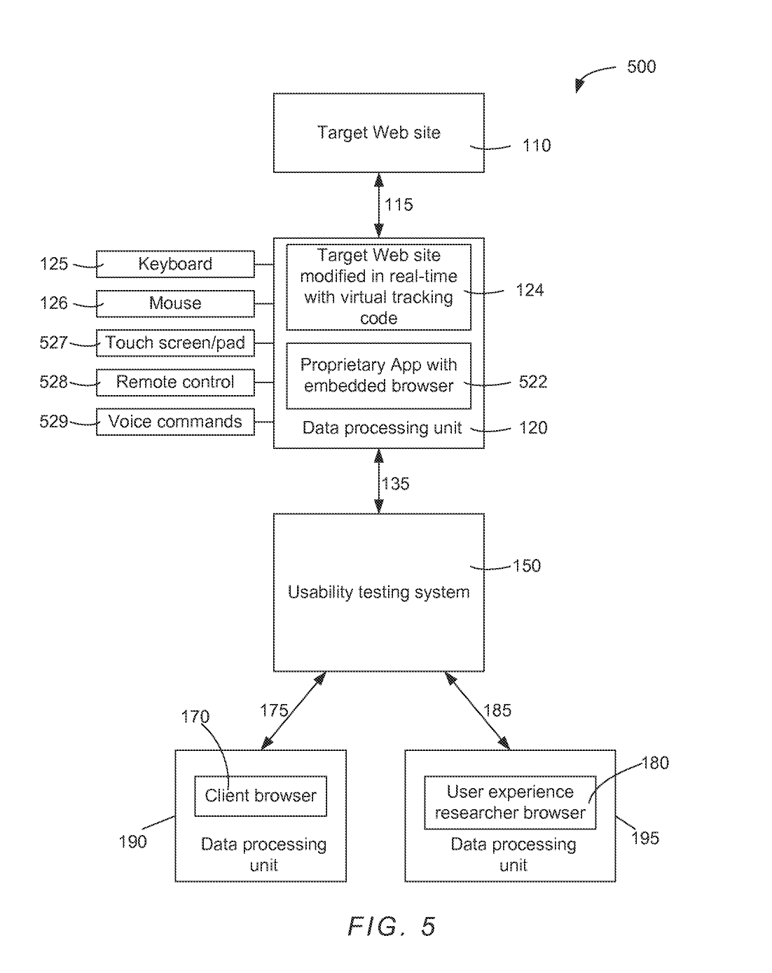

FIG. 5 is a simplified block diagram illustrating a user testing platform 500 of the present invention. User testing platform 500 includes the same features as user testing platform 100A depicted in FIG. 1A, with the following exceptions. FIG. 5 depicts user testing platform 500 may be used to perform unmoderated remote usability testing of the target web site 110. Data processing unit 120 may be adapted to run a proprietary app software program including an embedded in-app browser 522. In one embodiment, data processing unit 120 may include a mobile device and/or a television (TV), which each includes an input/output device such as a display (not shown). For example, the mobile device may include a laptop, a tablet, a mini-tablet, a smartphone, a cellphone, a pad, a mini-pad, a browser, or a wearable computing device. Data processing unit 120 processing unit may include at least one of the following input/output devices; the keyboard 125, the mouse 126, a touch screen or pad 527, a remote control 528, and/or a microphone for input of voice commands 529, in any combination. In one embodiment, data processing unit 120 may include a GPS receiver and/or cell phone tower positioning circuitry (not shown), which provides for gathering by the platform the geo-location of the data processing unit associated with at least one of the multitude of participants.

In one embodiment, proprietary app software program including the embedded in-app browser 522 may be run on data processing unit 120 by one of the study participants, to access target web site 110 using the embedded web browser module running in the proprietary app software program. In one embodiment, proprietary app software program including the embedded in-app browser 522 may modify the target web site in real-time by inserting the virtual tracking code to target web site 110 in real-time while the target web site is being downloaded to the data processing unit 120. The virtual tracking code enables the proprietary app software program including the embedded in-app browser 522 to automatically present the plurality of tasks to the participants and gather the plurality of responses from the participants.

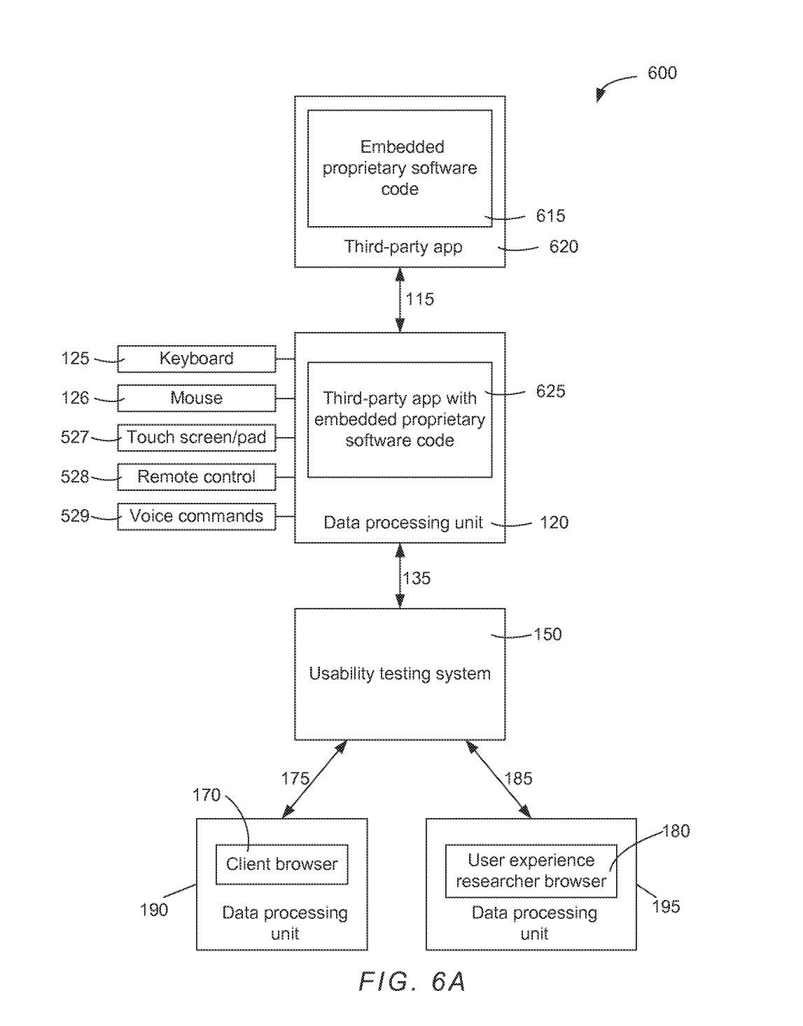

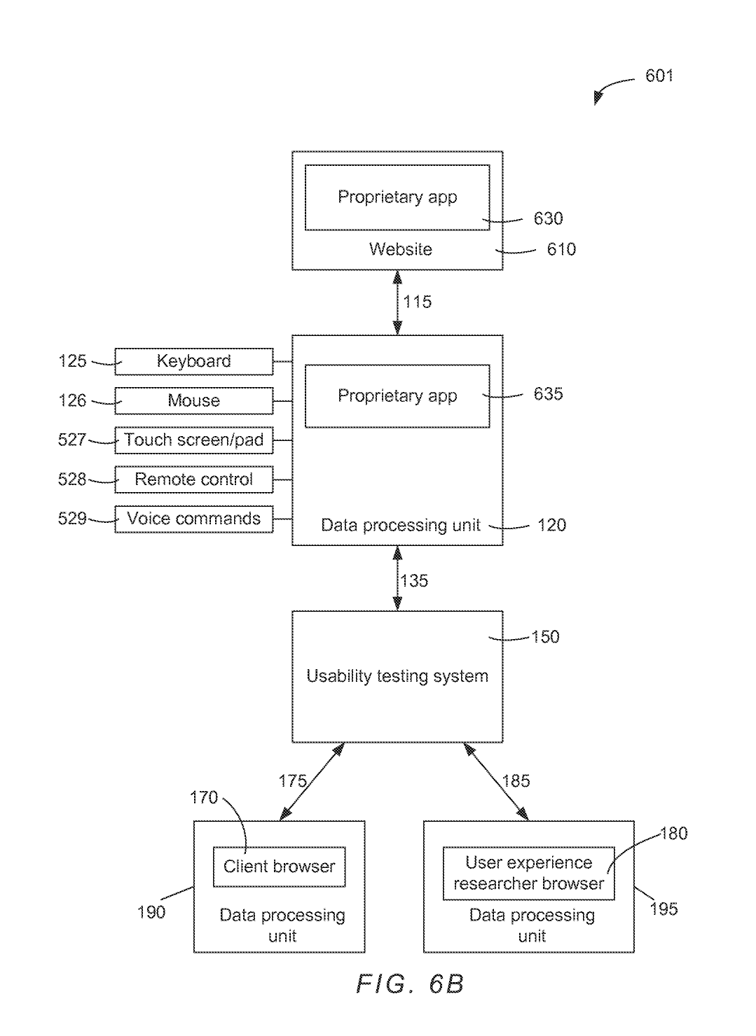

FIG. 6A is a simplified block diagram illustrating a user testing platform 600 of the present invention. User testing platform 600 includes the same features as user testing platform 100A depicted in FIG. 1A and user testing platform 500 depicted in FIG. 5, with the following exceptions. FIG. 6A depicts user testing platform 600 may be used to perform unmoderated remote usability testing of a target app software program 620, which includes embedded proprietary software code 615 similar to the virtual tracking code. In other words, proprietary software code 615 is added to existing target app software program 620. Data processing unit 120 may be adapted to download from the cloud and run a target app software program including embedded proprietary software code 625.

In one embodiment, target app software program including embedded proprietary software code 625 may be run on data processing unit 120 by one of the study participants. In one embodiment, target app software program including embedded proprietary software code 625 embeds the virtual tracking code in the target app software program before or during downloading to data processing unit 120. In other words, The virtual tracking code enables target app software program including embedded proprietary software code 625 to automatically present the plurality of tasks and gather the plurality of responses.

FIG. 6B is a simplified block diagram illustrating a user testing platform 601 of the present invention. User testing platform 600 includes the same features as user testing platform 100A depicted in FIG. 1A and user testing platform 600 depicted in FIG. 6A, with the following exceptions. FIG. 6B depicts user testing platform 601 may be used to perform unmoderated remote usability testing of a proprietary app software program 630. Data processing unit 120 may be adapted to download from a website 610 in the cloud and run a proprietary app software program 635.

In one embodiment, proprietary app software program 635 may be run on data processing unit 120 by one of the study participants. In one embodiment, proprietary app software program 635 includes the virtual tracking code before downloading from a website 610 to data processing unit 120. In other words, the virtual tracking code is not added to the app software program as a separate module but is instead resident in the native proprietary app software program 635. The virtual tracking code enables proprietary app software program 635 to automatically present the plurality of tasks and gather the plurality of responses.

According to one embodiment of the present invention, a computer-implemented method is presented for performing unmoderated remote usability testing of an executable software module. In one embodiment the executable software module may include target web site 110 depicted in FIG. 5. In another embodiment, the executable software module may include an app software program. In one embodiment, an app software program may include target app software program 620 depicted in FIG. 6A. In another embodiment, an app software program may include proprietary app software program 610 depicted in FIG. 6B.

The method includes identifying a multitude of participants, each of the multitude of participants being equipped with data processing unit 120 adapted to receive a multitude of responses from the multitude of participants through at least one of the input/output devices referenced in FIG. 5 above. Each of the multitude of responses is associated with using the executable software module being tested. The method further includes, connecting the multitude of participants with a server, such as for example data collecting server 260 or virtual moderator server 230, as depicted in FIG. 2. The server or servers are configured to interface with at least one user experience researcher 181 to identify the plurality of tasks, to gather the plurality of responses; and to analyze the plurality of responses with an analytics module 280 to determine the usability of the executable software module as described above. The method further includes automatically presenting at least one of a multitude of tasks associated with at least one usability metric of the executable software module to at least one of the multitude of participants, and gathering the at least one of the multitude of responses related to the at least one of the multitude of tasks.

In one embodiment, identifying a participant may include evaluating the gathered responses of the participant against a set of profiles, as described above. In another embodiment, the set of profiles of the participants are directed by the tasks. In one embodiment, participants may be eliminated from the usability study based on the determined profiles.

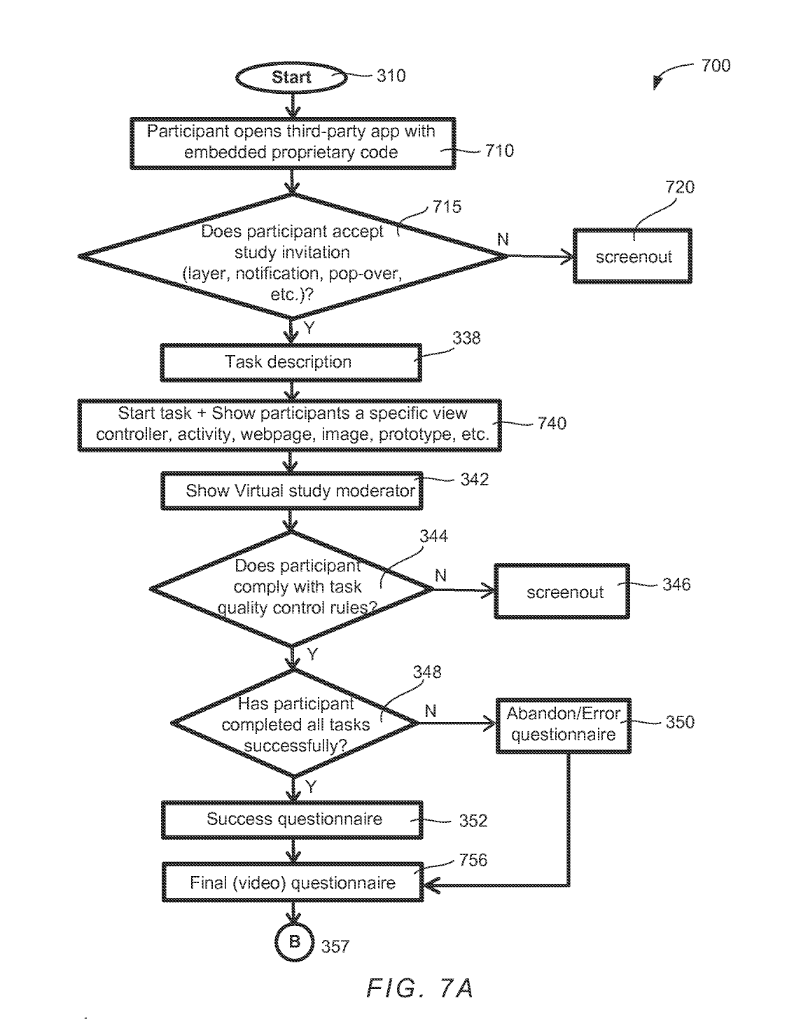

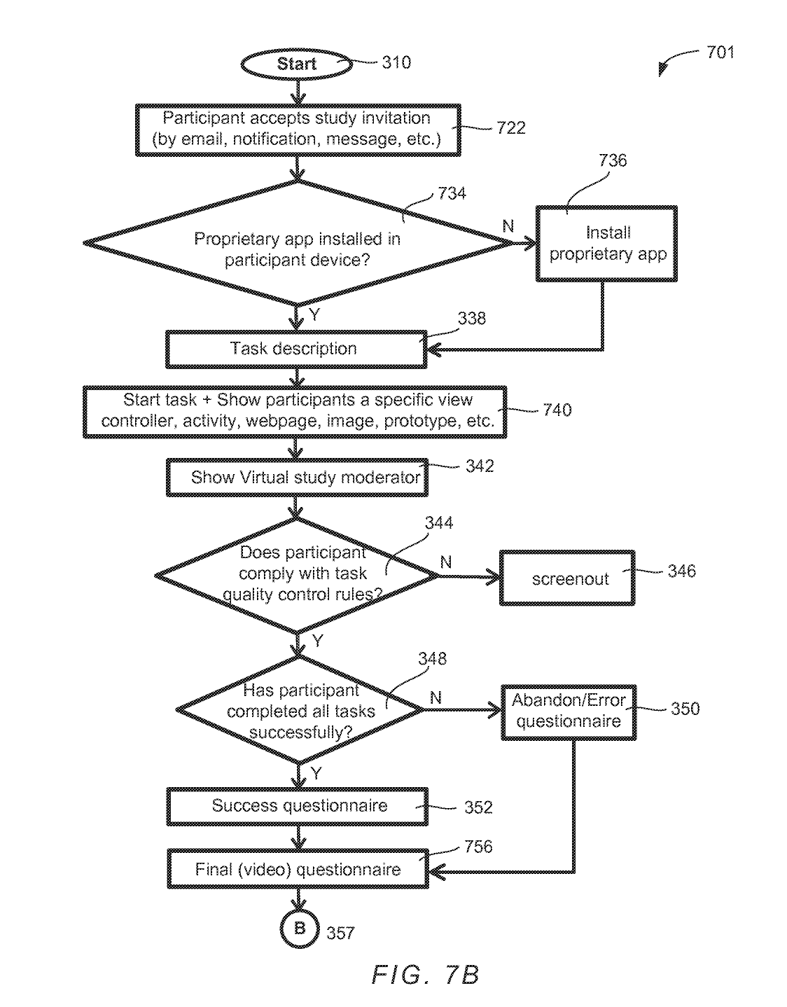

FIG. 7A is a flow diagram 700 of an exemplary process for gathering usability data for the embodiment depicted in FIG. 6A, according to an embodiment of the present invention. Flow diagram 700 includes the same features as the flow diagram depicted in FIG. 3B, with the following exceptions. Referring simultaneously to FIGS. 6A and 7A, after starting at step 310 the participant may open 710 on data processing unit 120 target app software program 620, which includes embedded proprietary software code 615. In one embodiment, embedding proprietary software code 615 or tracking code in target app software program 620 may be done prior to adding target app software program 620 to the cloud, before target app software program 625 is downloaded to the participant's data processing unit 120.

In one embodiment, because the target app software program 625 is running on data processing unit 120, embedded proprietary software code 615 may present on the display of data processing unit 120 a layer, notification, pop-over, pop-up, or the like that asks the participant to accept 715 a presented usability study invitation. If the participant declines to accept the usability study invitation, the participant may be screened out 720 of the usability study.

In one embodiment, the tracking code is adapted to automatically present the plurality of tasks and gather the plurality of responses. The task or tasks associated with at least one usability metric of the executable software module are automatically described or presented 338 to participants if the participant agrees to accept the usability study invitation. In one embodiment, automatically presenting may include randomly assigning one or more of the tasks to the participants. In another embodiment, one or more of the tasks may be automatically presented to the participants from a predefined list stored in a database of the data processing unit 120 or of one of the servers. In one embodiment, the tasks may include a card sorting study for optimizing a usability of the executable software module.

Then, embedded proprietary software code 615 may start 740 the task by showing the participants a specific presentation, and start to gather the participant's responses related to the tasks. In one embodiment, the specific presentation may include a view, activity, controller, webpage, image prototype, and/or the like, that are associated with the task using target app software program 625 for the purpose of determining the usability of target app software program 625.

In one embodiment, the responses from the participants may include at least one of a click, a scroll, a keystroke, a time, a keyword, a mouse coordinate, a mouse event, a swipe, a tap, a finger coordinate, a finger gesture, a finger event, an eye gesture, a body gesture, a body motion, a voice command, a date, a performance metric of the executable software module, or a text input. The responses may depend, for example, on the type of input/output devices that are included in data processing unit 120 and/or what features are enabled on the target app software program 625 to exploit those available input/output devices. In one embodiment, a response may be tagged or marked with time, date, and/or geo-location information. In one embodiment, gathering the responses includes capturing a predefined number of responses per second.

In one embodiment, gathering the responses may include validating the responses based on a multitude of quality standards and storing the validated multitude of responses into a multitude of categories using a binning module.

In one embodiment, after completing all the tasks and/or replying to a success questionnaire, the participants may be requested 756 to provide a video response to a question related to a usability of the executable software module. For example, for the final video questionnaire, the participants may be requested to do a retrospective think aloud about an experience of the participant using the executable software module, or about trying to achieve a goal of the participant related to the executable software module. In one embodiment, the response to the final video questionnaire may be captured using a video camera on data processing unit 120, the response including the participant's facial expressions captured soon after completing the presented tasks. In one embodiment, after the participant's responses are captured, the responses may be analyzed using an analytics module.

FIG. 7B is a flow diagram 701 of an exemplary process for gathering usability data for the embodiment depicted in FIG. 6B, according to an embodiment of the present invention. Flow diagram 701 includes the same features as the flow diagram depicted in FIG. 3B and FIG. 7A, with the following exceptions. Referring simultaneously to FIGS. 6B and 7B, after starting at step 310 the participant may accept 722 the study invitation. In one embodiment, the invitation may have been presented or the participant recruited via email, notification, message, and the like. The software checks 734 if proprietary app software program 630 is installed on participant's data processing unit 120. If proprietary app software program 630 is not installed, data processing unit 120 will install proprietary app software program 630. Once proprietary app software program 630 is installed, data processing unit 120 may run proprietary app software program 630 to automatically present the multitude of tasks and gather the plurality of responses.

According to one embodiment of the present invention, gathering a response from one of the participants may include forming a compressed video including a multitude of images of a display of data processing unit 120 running the executable software module. The compressed video may be stored. The compressed video may provide the user experience researcher an efficient playback of the participant's responses to the presented tasks. The video may be compressed by saving images when a new response is provided by the participant, or when a new image is displayed on the participant's display with or without an associated response. Thus, duplicate images without a new response may not be saved, resulting in a compressed video stream.

At least one of the multitude of responses associated with at least one of the multitude of images is stored. In other words, the response may be associated with the display image present on data processing unit 120 concurrently in time when that response took place. In one embodiment, at least one of the multitude of responses is embedded as a graphical representation on the associated at least one of the multitude of images on the compressed video. For example, a finger touch on a touch sensitive display screen may be represented graphically as a yellow ring appearing on the image where the participant's finger touched the touch sensitive display screen. In another embodiment, at least one of the multitude of responses is embedded as an audio representation on the associated at least one of the multitude of images on the compressed video. For example, a voice command detected by data processing unit 120 may be recorded as compressed or uncompressed audio recording or a mouse click may be represented by a clicking sound in the compressed video stream. In one embodiment distinct predefined sounds may be associated with certain participant responses.

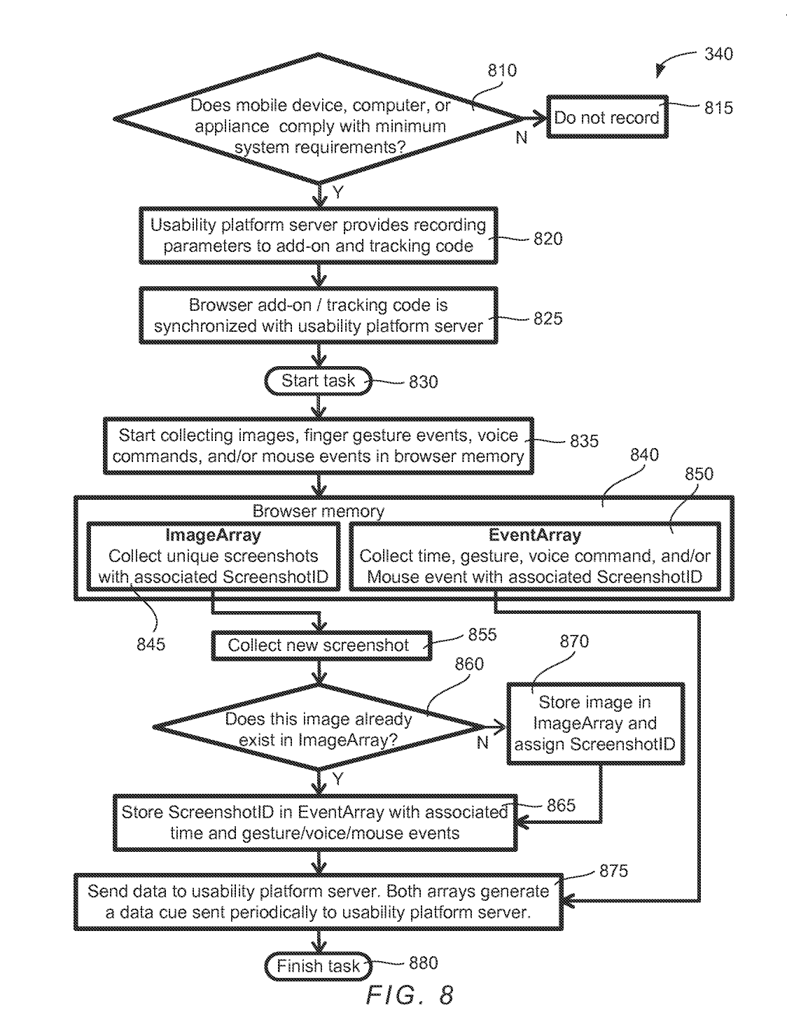

FIG. 8 is a flow diagram 740 of an exemplary process for presenting a task and recording a response for the embodiments depicted in FIGS. 7A-7B, according to an embodiment of the present invention. Gathering the multitude of responses may include collecting a multitude of images of a display of data processing unit 120 running the executable software module. Flow diagram 740 may depict features similar to the start task, show participants a specific presentation, and gather responses step 740 in FIGS. 7A-7B. The data processing unit 120, which may be a mobile device, computer, or appliance is checked 810 to determine if it complies with minimum system requirements, such as video and/or audio recording capability, sufficient battery charge, free memory capacity, and the like. If data processing unit 120 does not meet minimum system requirements, no recording 815 is done.

Referring simultaneously to FIGS. 5, 6A, 6B, and 8, if data processing unit 120 meets minimum system requirements, then the tracking code within proprietary app software program including embedded in-app browser 522, target app software program including embedded proprietary software code 625, or proprietary app software program 635 may contact a server in usability testing system 150, herein also referred to as “usability platform server”, to determine what to do. Then, usability testing system 150 may provide 820 recording parameters to add-on and additional tracking code if needed. In one embodiment recording parameters may include web pages and/or images that should not be recorded, maximum recording time, video screen resolution, frames per second or a predefined number of images per second, mouse movements per second, finger gestures per second, and the like. Then, the browser add-on or tracking code may be synchronized 825 with a server in usability testing system 150 based on the recording parameters, which in-turn sets initialized recording values such as initial time, maximum recording time, and the like.

Next, the tracking code may start recording when the task starts 830, e.g. the participant visits the web page or begins an app software program function. Then, predefined images or screenshots and predefined responses such as finger gesture events, voice commands, and/or mouse events may start to be collected 835 in browser memory. If video is to be captured 845 or recorded, then the tracking code may assign 855 an associated identifier, called a ScreenshotID, to each different one of the collected multitude of images. In other words, each image has a unique ScreenshotID associated with that image.

Two different memory arrays called ImageArray and EventArray may be used by the tracking code to compress the video recording. When at least one of the multitude of images is an image not previously stored, i.e. the image does not yet exist 860 in the ImageArray, then the tracking code stores 870 at least one of the multitude of images and the associated ScreenshotID in the ImageArray. If the image or screenshot already exists 860 in the ImageArray or after storing a new image in the ImageArray, then the tracking code stores 865 the ScreenshotID and at least one of the multitude of responses associated with at least one of the multitude of images in the EventArray. Each saved response event may have an associated ScreenshotID corresponding to the image that response occurred in, along with the time of occurrence. Therefore, duplicated images are not stored, which forms the compressed video. Further, all responses are captured as required by predefined requirements, irrespectively of whether a response occurs associated with a new image or not. Simply put, all responses are saved as required, while duplicate images are not saved. Saved images and responses are thus traceable in time. Next and if video capture 845 was not desired, both arrays generate 875 a data cue that may be sent along with the recorded data to a server in usability testing system 150 before the recording task is finished 880. In one embodiment, the data cue may be preconfigured to upload to usability testing system 150 periodically, such as every few seconds.

In one embodiment, usability testing system 150 may have an analytics section where researchers 181 may replay the information captured as the compressed video along with saved responses. In one embodiment, a video player may be an html proprietary software that reads the EventArray. The Events Array may provide time, saved response events, and the associated ScreenshotID for each saved response event. The proprietary video player may use the ScreenshotID to locate and display the real image stored in the ImageArray. At the same time, the video player graphically represents the response event within the video. In other words, the saved response events may be embedded in the associated image of the saved compressed video. For example, mouse events may be represented with a pointer, while clicks and finger taps may be represented as yellow circles. In one embodiment, the video player includes a clipping function to a mark time range of the compressed video where some interesting fact may have happened. Thus, researcher 181 may locate that interesting fact on the video at a later time. In one embodiment, the compressed video with embedded response events may be exported to different video formats, such as mpg4, through the proprietary video player software.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A computer-implemented method for performing unmoderated remote usability testing of an executable software module, the method comprising:
identifying, using one or more computer systems, a plurality of participants, each of the plurality of participants being equipped with a data processing unit adapted to receive a plurality of responses from the plurality of participants, each of the plurality of responses associated with using the executable software module;
connecting, using the one or more computer systems, the plurality of participants with a server;
automatically presenting, using the one or more computer systems, at least one of a plurality of tasks associated with at least one usability metric of the executable software module to at least one of the plurality of participants; and
gathering, using the one or more computer systems, the at least one of the plurality of responses related to the at least one of the plurality of tasks.

2. The method of claim 1 further comprising:
configuring, using the one or more computer systems, the server to interface with at least one user experience researcher to identify the plurality of tasks;
configuring, using the one or more computer systems, the server to gather the plurality of responses; and
configuring, using the one or more computer systems, the server to analyze the plurality of responses with an analytics module to determine the usability of the executable software module.

3. The method of claim 1, wherein the data processing unit includes a mobile device or a television, wherein the mobile device includes at least one of a laptop, a tablet, a mini-tablet, a smartphone, a cellphone, a pad, a mini-pad, a browser, or a wearable computing device.

4. The method of claim 1, wherein identifying includes evaluating, using the one or more computer systems, the gathered at least one of the plurality of responses against a set of profiles.

5. The method of claim 1, wherein identifying includes determining, using the one or more computer systems, a profile of the plurality of participants directed by the plurality of tasks.

6. The method of claim 5 further including eliminating, using the one or more computer systems, at least one of the plurality of participants based on the determined profile.

7. The method of claim 1, wherein automatically presenting includes:
running, using the one or more computer systems, on the data processing unit an app software program including an embedded web browser module, wherein the executable software module is a target web site; and
accessing, using the one or more computer systems, the target web site using the embedded web browser module.

8. The method of claim 7, wherein automatically presenting further includes modifying, using the one or more computer systems, the target web site in real-time with a tracking code to automatically present the plurality of tasks and gather the plurality of responses.

9. The method of claim 8, wherein the tracking code is a JavaScript code.

10. The method of claim 1, wherein the executable software module includes an app software program.

11. The method of claim 10, wherein automatically presenting includes:
embedding, using the one or more computer systems, a tracking code in the app software program, the tracking code adapted to automatically present the plurality of tasks and gather the plurality of responses; and
running, using the one or more computer systems, on the data processing unit the app software program.

12. The method of claim 10, wherein automatically presenting includes running, using the one or more computer systems, on the data processing unit the app software program to automatically present the plurality of tasks and gather the plurality of responses.

13. The method of claim 1, wherein automatically presenting includes randomly assigning, using the one or more computer systems, one or more tasks of the plurality of tasks to the plurality of participants.

14. The method of claim 1 further comprising storing, using the one or more computer systems, a predefined list in a database of the one or more computer systems, wherein the plurality of tasks is automatically presented from the predefined list.

15. The method of claim 1, wherein the plurality of tasks includes a card sorting study for optimizing, using the one or more computer systems, a usability of the executable software module.

16. The method of claim 1, wherein the plurality of responses includes at least one of a click, a scroll, a keystroke, a time, a keyword, a mouse coordinate, a mouse event, a swipe, a tap, a finger coordinate, a finger gesture, a finger event, an eye gesture, a body gesture, a body motion, a voice command, a date, a performance metric of the executable software module, or a text input.

17. The method of claim 1, wherein gathering includes:
forming, using the one or more computer systems, a compressed video including a plurality of images of a display of the data processing unit running the executable software module;
storing, using the one or more computer systems, the compressed video; and
storing, using the one or more computer systems, the at least one of the plurality of responses associated with at least one of the plurality of images.

18. The method of claim 17 further including embedding, using the one or more computer systems, the at least one of the plurality of responses as a graphical representation on the associated at least one of the plurality of images on the compressed video.

19. The method of claim 17 further including embedding, using the one or more computer systems, the at least one of the plurality of responses as an audio representation on the associated at least one of the plurality of images on the compressed video.

20. The method of claim 1, wherein gathering further includes:
collecting, using the one or more computer systems, a plurality of images of a display of the data processing unit running the executable software module;
assigning, using the one or more computer systems, an associated identifier to each different one of the collected plurality of images;
storing, using the one or more computer systems, the associated identifier and the at least one of the plurality of responses associated with at least one of the plurality of images; and
storing, using the one or more computer systems, the associated identifier and at least one of the plurality of images when the at least one of the plurality of images is an image not previously stored to form a compressed video.

21. The method of claim 20, wherein collecting includes capturing, using the one or more computer systems, a predefined number of images per second.

22. The method of claim 1, wherein gathering includes capturing, using the one or more computer systems, a predefined number of the plurality of responses per second.

23. The method of claim 1, wherein gathering includes sending, using the one or more computer systems, the plurality of responses to the server via a communication link.

24. The method of claim 23, wherein the communication link uses a packet protocol conforming to an Internet protocol.

25. The method of claim 1, wherein gathering includes:
validating, using the one or more computer systems, the plurality of responses based on a plurality of quality standards; and
storing, using the one or more computer systems, the validated plurality of responses into a plurality of categories using a binning module.

26. The method of claim 1 further including gathering, using the one or more computer systems, a geo-location of the data processing unit associated with the at least one of the plurality of participants.

27. The method of claim 1 further including requesting, using the one or more computer systems, at least one of the plurality of participants to provide a video response related to a usability of the executable software module.

28. The method of claim 1 further comprising analyzing, using the one or more computer systems, the plurality of responses using an analytics module.

29. A system for performing unmoderated remote usability testing of an executable software module, the method comprising:
a first processor in a data processing unit adapted to execute the executable software module;
a second processor in a server; and
a memory storing a set of instructions which when executed by the first processor and the second processor configures the first processor and the second processor to:
identify a plurality of participants, each of the plurality of participants being equipped with the data processing unit adapted to receive a plurality of responses from the plurality of participants, each of the plurality of responses associated with using the executable software module;
connect the plurality of participants with a server;
automatically present at least one of a plurality of tasks associated with at least one usability metric of the executable software module to at least one of the plurality of participants; and
gather the at least one of the plurality of responses related to the at least one of the plurality of tasks.

30. The system of claim 29, wherein the second processor is further configured to:
interface with at least one user experience researcher to identify the plurality of tasks;
gather the plurality of responses; and
analyze the plurality of responses with an analytics module to determine the usability of the executable software module.

31. The system of claim 29, wherein the data processing unit includes a mobile device or a television, wherein the mobile device includes at least one of a laptop, a tablet, a mini-tablet, a smartphone, a cellphone, a pad, a mini-pad, a browser, or a wearable computing device.

32. The system of claim 29, wherein to identify includes to evaluate the gathered at least one of the plurality of responses against a set of profiles.

33. The system of claim 29, wherein the first processor and the second processor are further configured to determine a profile of the plurality of participants directed by the plurality of tasks.

34. The system of claim 33, wherein the first processor and the second processor are further configured to eliminate at least one of the plurality of participants based on the determined profile.

35. The system of claim 29, wherein to automatically present includes:
to run on the data processing unit an app software program including an embedded web browser module, wherein the executable software module is a target web site; and
to access the target web site using the embedded web browser module.

36. The system of claim 35, wherein to automatically present further includes to modify the target web site in real-time with a tracking code to automatically present the plurality of tasks and gather the plurality of responses.

37. The system of claim 36, wherein the tracking code is a JavaScript code.

38. The system of claim 29, wherein the executable software module includes an app software program.

39. The system of claim 38, wherein to automatically present includes:
to embed a tracking code in the app software program, the tracking code adapted to automatically present the plurality of tasks and gather the plurality of responses; and
to run on the data processing unit the app software program.

40. The system of claim 38, wherein to automatically present includes to run on the data processing unit the app software program to automatically present the plurality of tasks and gather the plurality of responses.

41. The system of claim 29, wherein to automatically present includes to randomly assign one or more tasks of the plurality of tasks to the plurality of participants.

42. The system of claim 29, wherein the first processor and the second processor are further configured to store a predefined list in a database of the one or more computer systems, wherein the plurality of tasks is automatically presented from the predefined list.

43. The system of claim 29, wherein the plurality of tasks includes a card sorting study adapted to optimize a usability of the executable software module.

44. The system of claim 29, wherein the plurality of responses includes at least one of a click, a scroll, a keystroke, a time, a keyword, a mouse coordinate, a mouse event, a swipe, a tap, a finger coordinate, a finger gesture, a finger event, an eye gesture, a body gesture, a body motion, a voice command, a date, a performance metric of the executable software module, or a text input.

45. The system of claim 29, wherein to gather includes:
to form a compressed video including a plurality of images of a display of the data processing unit running the executable software module;
to store the compressed video; and
to store the at least one of the plurality of responses associated with at least one of the plurality of images.

46. The system of claim 45 wherein to gather further includes to embed the at least one of the plurality of responses as a graphical representation on the associated at least one of the plurality of images on the compressed video.

47. The system of claim 45 wherein to gather further includes to embed the at least one of the plurality of responses as an audio representation on the associated at least one of the plurality of images on the compressed video.

48. The system of claim 29, wherein to gather further includes:
to collect a plurality of images of a display of the data processing unit running the executable software module;
to assign an associated identifier to each different one of the collected plurality of images;
to store the associated identifier and the at least one of the plurality of responses associated with at least one of the plurality of images; and
to store the associated identifier and at least one of the plurality of images when the at least one of the plurality of images is an image not previously stored to form a compressed video.

49. The system of claim 48, wherein to collect includes to capture a predefined number of images per second.

50. The system of claim 29, wherein to gather includes to capture a predefined number of the plurality of responses per second.

51. The system of claim 29, wherein to gather includes to send the plurality of responses to the server via a communication link.

52. The system of claim 51, wherein the communication link uses a packet protocol conforming to an Internet protocol.

53. The system of claim 29, wherein to gather includes:
to validate the plurality of responses based on a plurality of quality standards; and
to store the validated plurality of responses into a plurality of categories using a binning module.

54. The system of claim 29 wherein the first processor and the second processor are further configured to gather a geo-location of the data processing unit associated with the at least one of the plurality of participants.

55. The system of claim 29 wherein the first processor and the second processor are further configured to ask at least one of the plurality of participants to provide a video response related to a usability of the executable software module.

56. The system of claim 29 wherein the first processor and the second processor are further configured to analyze the plurality of responses using an analytics module.

57. A non-transitory computer-readable medium storing computer-executable code for performing unmoderated remote usability testing of an executable software module, the non-transitory computer-readable medium comprising:
code for identifying a plurality of participants, each of the plurality of participants being equipped with a data processing unit adapted to receive a plurality of responses from the plurality of participants, each of the plurality of responses associated with using the executable software module;
code for connecting the plurality of participants with a server;
code for automatically presenting at least one of a plurality of tasks associated with at least one usability metric of the executable software module to at least one of the plurality of participants; and
code for gathering the at least one of the plurality of responses related to the at least one of the plurality of tasks.

58. The non-transitory computer-readable medium of claim 57 further comprising:
code for configuring the server to interface with at least one user experience researcher to identify the plurality of tasks;
code for configuring the server to gather the plurality of responses; and
code for configuring the server to analyze the plurality of responses with an analytics module to determine the usability of the executable software module.

59. The non-transitory computer-readable medium of claim 57, wherein the data processing unit includes a mobile device or a television, wherein the mobile device includes at least one of a laptop, a tablet, a mini-tablet, a smartphone, a cellphone, a pad, a mini-pad, television, a browser, or a wearable computing device.

60. The non-transitory computer-readable medium of claim 57, wherein the code for identifying includes code for evaluating the gathered at least one of the plurality of responses against a set of profiles.

61. The non-transitory computer-readable medium of claim 57 further comprising code for determining a profile of the plurality of participants directed by the plurality of tasks.

62. The non-transitory computer-readable medium of claim 61 further comprising code for eliminating at least one of the plurality of participants based on the determined profile.

63. The non-transitory computer-readable medium of claim 57, wherein the code for automatically presenting includes:
code for running on the data processing unit an app software program including an embedded web browser module, wherein the executable software module is a target web site; and
code for accessing the target web site using the embedded web browser module.

64. The non-transitory computer-readable medium of claim 63, wherein the code for automatically presenting further includes code for modifying the target web site in real-time with a tracking code to automatically present the plurality of tasks and gather the plurality of responses.

65. The non-transitory computer-readable medium of claim 64, wherein the tracking code is a JavaScript code.

66. The non-transitory computer-readable medium of claim 57, wherein the executable software module includes an app software program.

67. The non-transitory computer-readable medium of claim 66, wherein the code for automatically presenting includes:
code for embedding a tracking code in the app software program, the tracking code adapted to automatically present the plurality of tasks and gather the plurality of responses; and
code for running on the data processing unit the app software program.

68. The non-transitory computer-readable medium of claim 66, wherein the code for automatically presenting includes code for running on the data processing unit the app software program to automatically present the plurality of tasks and gather the plurality of responses.

69. The non-transitory computer-readable medium of claim 57, wherein the code for automatically presenting includes code for randomly assigning one or more tasks of the plurality of tasks to the plurality of participants.

70. The non-transitory computer-readable medium of claim 57 further comprising code for storing a predefined list in a database of the one or more computer systems, wherein the plurality of tasks is automatically presented from the predefined list.

71. The non-transitory computer-readable medium of claim 57, wherein the plurality of tasks includes a card sorting study adapted to optimize a usability of the executable software module.

72. The non-transitory computer-readable medium of claim 57, wherein the plurality of responses includes at least one of a click, a scroll, a keystroke, a time, a keyword, a mouse coordinate, a mouse event, a swipe, a tap, a finger coordinate, a finger gesture, a finger event, an eye gesture, a body gesture, a body motion, a voice command, a date, a performance metric of the executable software module, or a text input.

73. The non-transitory computer-readable medium of claim 57, wherein the code for gathering includes:
code for forming a compressed video including a plurality of images of a display of the data processing unit running the executable software module;
code for storing the compressed video; and
code for storing the at least one of the plurality of responses associated with at least one of the plurality of images.

74. The non-transitory computer-readable medium of claim 73 further including code for embedding the at least one of the plurality of responses as a graphical representation on the associated at least one of the plurality of images on the compressed video.

75. The non-transitory computer-readable medium of claim 73 further including code for embedding the at least one of the plurality of responses as an audio representation on the associated at least one of the plurality of images on the compressed video.

76. The non-transitory computer-readable medium of claim 57, wherein the code for gathering further includes:
code for collecting a plurality of images of a display of the data processing unit running the executable software module;
code for assigning an associated identifier to each different one of the collected plurality of images;
code for storing the associated identifier and the at least one of the plurality of responses associated with at least one of the plurality of images; and
storing the associated identifier and at least one of the plurality of images when the at least one of the plurality of images is an image not previously stored to form a compressed video.

77. The non-transitory computer-readable medium of claim 76, wherein the code for collecting includes code for capturing a predefined number of images per second.

78. The non-transitory computer-readable medium of claim 57, wherein the code for gathering includes code for capturing a predefined number of the plurality of responses per second.

79. The non-transitory computer-readable medium of claim 57, wherein the code for gathering includes code for sending the plurality of responses to the server via a communication link.

80. The non-transitory computer-readable medium of claim 79, wherein the communication link uses a packet protocol conforming to an Internet protocol.

81. The non-transitory computer-readable medium of claim 57, wherein the code for gathering includes:
code for validating the plurality of responses based on a plurality of quality standards; and
code for storing the validated plurality of responses into a plurality of categories using a binning module.

82. The non-transitory computer-readable medium of claim 57 further including code for gathering a geo-location of the data processing unit associated with the at least one of the plurality of participants.

83. The non-transitory computer-readable medium of claim 57 further including code for asking at least one of the plurality of participants to provide a video response related to a usability of the executable software module.

84. The non-transitory computer-readable medium of claim 57 further comprising code for analyzing the plurality of responses using an analytics module.
